(19) United States
(12) Patent Application Publication
(10) Pub. No.: US 2026/0326329 A1
(43) Pub. Date: Oct. 22, 2026

(54) METHOD AND SYSTEM FOR GENERATING NESTING LAYOUTS FOR MULTI-HEAD CUTTING MACHINES

(71) Applicant: HCL Technologies Limited, New Delhi (IN)

(72) Inventors: Yash Kumar Dungerpuria, Navi Mumbai (IN); Moiz Esmail Bootwala, Navi Mumbai (IN)

(21) Appl. No.: 19/463,195

(22) Filed: Jan. 29, 2026

(30) Foreign Application Priority Data
Apr. 19, 2025 (IN) 202511037814

(51) Int. Cl. B26D 5/00; G06F 30/20; G06F 113/24

(52) U.S. Cl. CPC B26D 5/005; G06F 30/20; B26D 2005/002; G06F 2113/24

(57) ABSTRACT

This disclosure relates to method and system for generating nesting layouts for multi-head cutting machines. The method includes receiving a 2D sheet drawing, one or more 2D part drawings, and a set of nesting parameters from a User Interface (UI). The method may further include creating a plurality of regions on the 2D sheet drawing based on the number of the cutting heads. For each region of the plurality of regions, the method may further include fitting a set of copies of each of the one or more 2D part drawings in the region at an optimal orientation and at an optimal position, to obtain a plurality of nested copies in the region.

### TECHNICAL FIELD

This disclosure relates generally to nesting, and more particularly to method and system for generating nesting layouts for multi-head cutting machines.

### BACKGROUND

Manufacturing industries may manufacture a plurality of objects (for example, 3-dimensional (3D) objects and 2–dimensional (2D) objects). While manufacturing the 2D objects, shapes of the 2D objects may be placed on a larger 2D sheets of raw material by the process of nesting. Nesting is a process of placing smaller 2D shapes in a larger 2D shape using packing algorithms such that minimum area of the larger 2D shape (and hence minimum raw material) is wasted. The larger 2D sheets may be made of wood, metal, leather, textile, paper, glass, etc. The shapes of the 2D objects and the larger 2D sheets may be rectangular in shape or non-rectangualr in shape.

In the present state of art, an overlap (or superimposition) between toolpaths of neighbouring parts may be allowed while nesting to save free space on the 2D sheet. When the overlapping of toolpaths is allowed, nesting process as well as cutting process may be optimized. However, conventional nesting techniques are configured for nesting parts with overlapping toolpaths for single head cutting machines. Such techniques fail to optimally provide for nesting with overlapping toolpaths for multi-head cutting machines, thereby failing to make most of various advantages offered by the multi-head cutting machines, such as saving overall cutting time.

Thus, the present invention is directed to overcome one or more limitations stated above or any other limitations associated with the known arts.

### SUMMARY

In one embodiment, a method for generating nesting layouts for multi-head cutting machines is disclosed. In one example, the method may include receiving a 2D sheet drawing, one or more 2D part drawings, and a set of nesting parameters from a User Interface (UI). The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath region. The method may further include creating a plurality of regions on the 2D sheet drawing based on the number of the cutting heads. Each of the plurality of the regions corresponds to a cutting head of the multi-head cutting machine. For each region of the plurality of regions, the method may further include fitting a set of copies of each of the one or more 2D part drawings in the region at an optimal orientation and at an optimal position, to obtain a plurality of nested copies in the region. The toolpath region of each of the plurality of nested copies is superimposable with toolpath regions of remaining of the plurality of nested copies. The set of copies is based on the set of nesting parameters.

In one embodiment, a system for generating nesting layouts for multi-head cutting machines is disclosed. In one example, the system may include a processor and a memory communicatively coupled to the processor. In one example, the memory may store processor-executable instructions, which, on execution, may cause the processor to receive a 2D sheet drawing, one or more 2D part drawings, and a set of nesting parameters from a UI. The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath region. The processor-executable instructions, on execution, may further cause the processor to create a plurality of regions on the 2D sheet drawing based on the number of the cutting heads. Each of the plurality of the regions corresponds to a cutting head of the multi-head cutting machine. For each region of the plurality of regions, the processor-executable instructions, on execution, may further cause the processor to fitting a set of copies of each of the one or more 2D part drawings in the region at an optimal orientation and at an optimal position, to obtain a plurality of nested copies in the region. The toolpath region of each of the plurality of nested copies is superimposable with toolpath regions of remaining of the plurality of nested copies. The set of copies is based on the set of nesting parameters.

In one embodiment, a non-transitory computer-readable medium storing computer-executable instructions for generating nesting layouts for multi-head cutting machines is disclosed. In one example, the stored instructions, when executed by a processor, may cause the processor to receive a 2D sheet drawing, one or more 2D part drawings, and a set of nesting parameters from a UI. The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath region. The operations may further include creating a plurality of regions on the 2D sheet drawing based on the number of the cutting heads. Each of the plurality of the regions corresponds to a cutting head of the multi-head cutting machine. For each region of the plurality of regions, the operations may further include fitting a set of copies of each of the one or more 2D part drawings in the region at an optimal orientation and at an optimal position, to obtain a plurality of nested copies in the region. The toolpath region of each of the plurality of nested copies is superimposable with toolpath regions of remaining of the plurality of nested copies. The set of copies is based on the set of nesting parameters.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for generating nesting layouts for multi-head cutting machines, in accordance with some embodiments.

FIG. 2 illustrates a functional block diagram of a system for generating nesting layouts for multi-head cutting machines, in accordance with some embodiments.

FIG. 3 illustrates a flow diagram of an exemplary process for generating nesting layouts for multi-head cutting machines, in accordance with some embodiments.

FIGS. 4A and 4B illustrate an exemplary nesting layout of 2D part drawings with superimposable toolpaths for multi-head cutting machines, in accordance with an embodiment.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

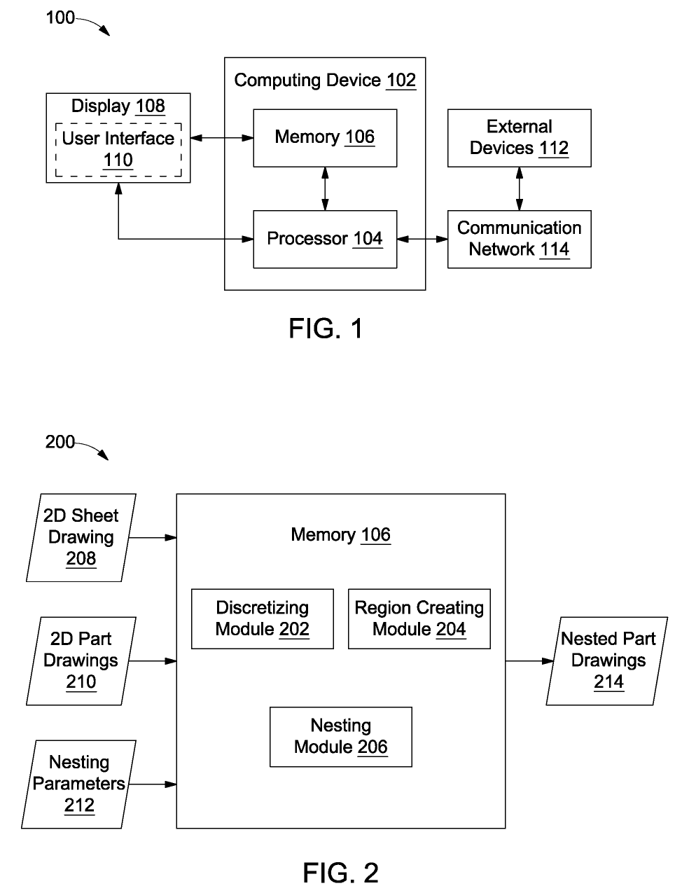

Referring now to FIG. 1, an exemplary system 100 for generating nesting layouts for multi-head cutting machines is illustrated, in accordance with some embodiments. Nesting is a process of fitting smaller 2-Dimensional (2D) shapes (drawings corresponding to 2D manufacturing parts) on a larger 2D shape (drawing corresponding to a 2D sheet of raw material) using packing algorithms such that minimum area of the larger 2D shape (and hence minimum raw material) is wasted when the 2D parts are cut from the 2D sheet. The system 100 may include a computing device 102 (for example, a server, a desktop, a laptop, a notebook, a netbook, a tablet, a smartphone, a mobile phone, or any other computing device), in accordance with some embodiments. The computing device 102 may generate nesting layouts with allowable toolpath overlap (superimposition) between nested part drawings. Additionally, the nesting layouts generated by the computing device 102 may be optimized for multi-head cutting machines.

As will be described in greater detail in conjunction with FIGS. 2-5, the computing device 102 may receive a 2D sheet drawing, one or more 2D part drawings, and a set of nesting parameters from a User Interface (UI). The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath. Further, the computing device 102 may create a plurality of regions on the 2D sheet drawing based on the number of the cutting heads. Each of the plurality of the regions corresponds to a cutting head of the multi-head cutting machine. For each region of the plurality of regions, the computing device 102 may fit a set of copies of each of the one or more 2D part drawings in the region at an optimal orientation and at an optimal position, to obtain a plurality of nested copies in the region. The toolpath region of each of the plurality of nested copies is superimposable with toolpath regions of remaining of the plurality of nested copies. The set of copies is based on the set of nesting parameters.

In some embodiments, the computing device 102 may include one or more processors 104 and a memory 106. The memory 106 may include a cache memory. The memory 106 may store instructions that, when executed by the one or more processors 104, may cause the one or more processors 104 to generate nesting layouts for a multi-head cutting machine, in accordance with aspects of the present disclosure. The memory 106 may also store various data (for example, 2D sheet drawing, 2D part drawings, set of nesting parameters, plurality of regions on the 2D sheet drawing, and the like) that may be captured, processed, and/or required by the system 100.

The system 100 may further include a display 108. The system 100 may interact with a user via a UI 110 accessible via the display 108. The system 100 may also include one or more external devices 112. In some embodiments, the computing device 102 may interact with the one or more external devices 112 over a communication network 114 for sending or receiving various data. The external devices 112 may include, but may not be limited to, a remote server, a digital device, or another computing system.

Referring now to FIG. 2, a functional block diagram of a system 200 for generating nesting layouts for multi-head cutting machines is illustrated, in accordance with some embodiments. FIG. 2 is explained in conjunction with FIG. 1. The system 200 may be analogous to the system 100. The system 200 may include, within the memory 106, a discretizing module 202, a region creating module 204, and a nesting module 206.

The discretizing module 202 may receive a 2D sheet drawing 208, one or more 2D part drawings 210, and a set of nesting parameters 212 from a UI (such as the UI 110). In an embodiment, the UI may be a Graphical User Interface (GUI). By way of an example, the set of nesting parameters 212 may include, but may not be limited to, a number of cutting heads of a multi-head cutting machine, dimensions of the 2D sheet drawing 208, dimensions of the 2D part drawing 210, and a limiting nesting number of copies for each of the 2D part drawings 210. Each of the 2D part drawings 210 may include a part region and a toolpath region.

Further, the discretizing module 202 may discretize geometric data of the 2D sheet drawing 208 to obtain a sheet pixel map. Additionally, for each copy of the set of copies of each of the 2D part drawings 210, the discretizing module 202 may discretize geometric data of the copy to obtain a copy pixel map. The copy pixel map may include a part region pixel map corresponding to the part region and a toolpath pixel map corresponding to the toolpath region. It should be noted that the toolpath pixel map is a superimposable pixel map when fitted on the sheet pixel map. As will be appreciated, the geometric data of the 2D part drawings 210 and the 2D sheet 208 are discretized so that computational time can be reduced drastically. The discretization step is critical so that geometric details are not lost, and at the same time, the overall computational time is reduced. This is done by converting the 2D part drawing and the 2D sheet into a respective collection of pixels or small cells (i.e., pixel maps). The discretizing module 202 may send the copy pixel map to the region creating module 204.

The region creating module 204 may create a plurality of regions on the 2D sheet drawing based on the number of the cutting heads. Each of the plurality of the regions corresponds to a cutting head of the multi-head cutting machine. By way of an example, the number of the cutting heads of the multi-head cutting machine may be 3. Thus, the region creating module 204 may divide the 2D sheet drawing into 3 regions of equal area. In an embodiment, the plurality of regions may be rectangular in shape. The number of the plurality of regions may be based on one of a maximum number of cutting heads to be used during cutting. Additionally, the plurality of regions is created on the 2D sheet 208 at a minimum distance (or an interval) from each other. The interval depends on a minimum distance necessary to be kept between the cutting heads of the multi-head cutting machine and the number of cutting heads of the multi-head cutting machine.

For example, when the limiting nesting number is 5 for a2D part drawing and the number of cutting heads of the multi-head cutting machine is 3, the region creating module 204 may perform a check to determine whether 3 regions of equal area can be created on the 2D sheet drawing 208. If such 3 regions cannot be created (i.e., area of the 2D sheet 208 is smaller than an area required for the 3 regions), the number of the plurality of regions would be reduced to next lower number which is 2 in the example considered.. Further, the region creating module 204 may send the plurality of regions to the nesting module 206.

For each region of the plurality of regions, the nesting module 206 may fit a set of copies of each of the one or more 2D part drawings 210 in the region at an optimal orientation and at an optimal position, to obtain a plurality of nested copies (or nested part drawings 214) in the region. Thus, each region of the 2D sheet drawing 208 may include the nested part drawings 214. It should be noted that the nested part drawings 214 include the set of copies of each of the input 2D part drawings 210. The toolpath region of each of the nested part drawings 214 is superimposable with toolpath regions of remaining of the nested part drawings 214. A number of the set of copies is based on the limiting nesting number of copies of each of the 2D part drawings 210 provided in the set of nesting parameters. For each 2D part drawing of the input 2D part drawings 210, the set of copies fitted on the 2D sheet drawing 208 is less than or equal to the limiting nesting number of copies for the 2D part drawing. In other words, number of the nested copies of a 2D part drawing can not exceed the limiting nesting number of copies for that 2D part drawing.

To fit the set of copies in the region, for each copy of the set of copies of each of the 2D part drawings 210, the nesting module 206 may determine the optimal position of the copy based on one of a position of previously fitted copy in the region or a predefined corner of the region. Further, the nesting module 206 may determine the optimal orientation of the copy based on a geometric intersection between two or more adjacent nested copies of the plurality of nested copies. It should be noted that for each of the set of copies, the optimal orientation and the optimal position of the copy are same in each of the plurality of regions on the 2D sheet drawing 208.

That is to say, nesting layout of the 2D part drawings 210 is the same for each of the plurality of regions. In other words, each region is considered individually for 2D part drawing placement. One by one, each copy of the 2D part drawing, with all permissible orientations is considered for placement in the region. The best fitting orientation is chosen for placement on the region. Once a particular orientation of a copy of a particular 2D part drawing is chosen for placement on the region, another copy of the same 2D part drawing is placed at the same orientation in other rectangular regions on the 2D sheet 208 separated by the interval. For example, if 4 regions are created on the 2D sheet 208, a particular orientation of a first copy is placed in a first region. Then, a second copy of the same2D part drawing as that of the first copy is placed at the same location relative to a second region. Similarly, the remaining copies are placed in the remaining regions on the 2D sheet 208. This arrangement of copies of the 2D part drawing allows for cutting of the same shape (i.e., the 2D part) with same orientation by 4 different cutting heads simultaneously during cutting operation. This leads to reduction in total cutting time required to cut all the 2D part shapes from the 2D sheet 208. In other words, this facilitates the cutting operation of parallel cutting heads of the multi-head cutting machine.

It should be noted that all such aforementioned modules 202 - 206 may be represented as a single module or a combination of different modules. Further, as will be appreciated by those skilled in the art, each of the modules 202 - 206 may reside, in whole or in parts, on one device or multiple devices in communication with each other. In some embodiments, each of the modules 202 - 206 may be implemented as dedicated hardware circuit comprising custom application-specific integrated circuit (ASIC) or gate arrays, off-the-shelf semiconductors such as logic chips, transistors, or other discrete components. Each of the modules 202 - 206 may also be implemented in a programmable hardware device such as a field programmable gate array (FPGA), programmable array logic, programmable logic device, and so forth. Alternatively, each of the modules 202 - 206 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together, but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for generating nesting layouts for multi-head cutting machines. For example, the exemplary system 100 and the associated computing device 102 may generate nesting layouts for multi-head cutting machines by the processes discussed herein. In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

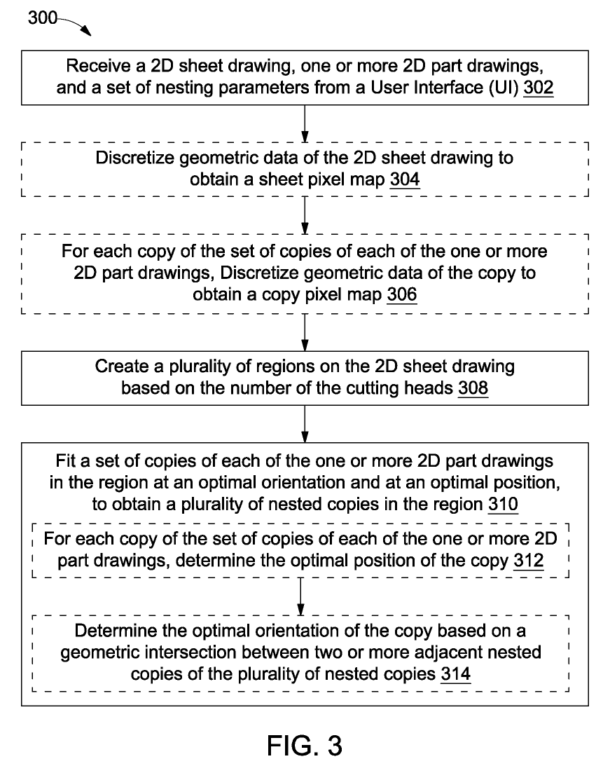

Referring now to FIG. 3, an exemplary process 300 for generating nesting layouts for multi-head cutting machines is depicted via a flowchart, in accordance with some embodiments. FIG. 3 is explained in conjunction with FIGS. 1 and 2. The process 300 may be implemented by the computing device 102 of the system 100. The process 300 may include receiving, by a discretizing module (for example, the discretizing module 202), a 2D sheet drawing (for example, the 2D sheet drawing 208), one or more 2D part drawings (for example, the 2D part drawings 210), and a set of nesting parameters (for example, the nesting parameters 212) from a UI, at step 302. The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath region.

In some embodiments, the process 300 may include discretizing, by the discretizing module, geometric data of the 2D sheet drawing to obtain a sheet pixel map, at step 304. Further, for each copy of the set of copies of each of the one or more 2D part drawings, the process 300 may include discretizing, by the discretizing module, geometric data of the copy to obtain a copy pixel map, at step 306. The copy pixel map may include a part region pixel map corresponding to the part region and a toolpath pixel map corresponding to the toolpath region. The toolpath pixel map is a superimposable pixel map when fitted on the sheet pixel map.

Further, the process 300 may include creating, by a region creating module (for example, the region creating module 204), a plurality of regions on the 2D sheet drawing based on the number of the cutting heads, at step 308. Further, for each region of the plurality of regions, the process 300 may include fitting, by a nesting module (for example, the nesting module 206), a set of copies of each of the one or more 2D part drawings in the region at an optimal orientation and at an optimal position, to obtain a plurality of nested copies in the region, at step 310. The toolpath region of each of the plurality of nested copies is superimposable with toolpath regions of remaining of the plurality of nested copies. The set of copies is based on the set of nesting parameters. The step 310 may include step 312 and step 314.

For each copy of the set of copies of each of the one or more 2D part drawings, the process 300 may include determining, by the nesting module, the optimal position of the copies, at step 312. The determination of the optimal position may be based on one of a position of a previously fitted copy in the region or a predefined corner of the region. Further the process 300 may include determining, by the nesting module, the optimal orientation of the copy based on a geometric intersection between two or more adjacent nested copies of the plurality of nested copies, at step 314. For each copy of the set of copies, the optimal orientation and the optimal position of the copy are same in each of the plurality of regions on the 2D sheet drawing.

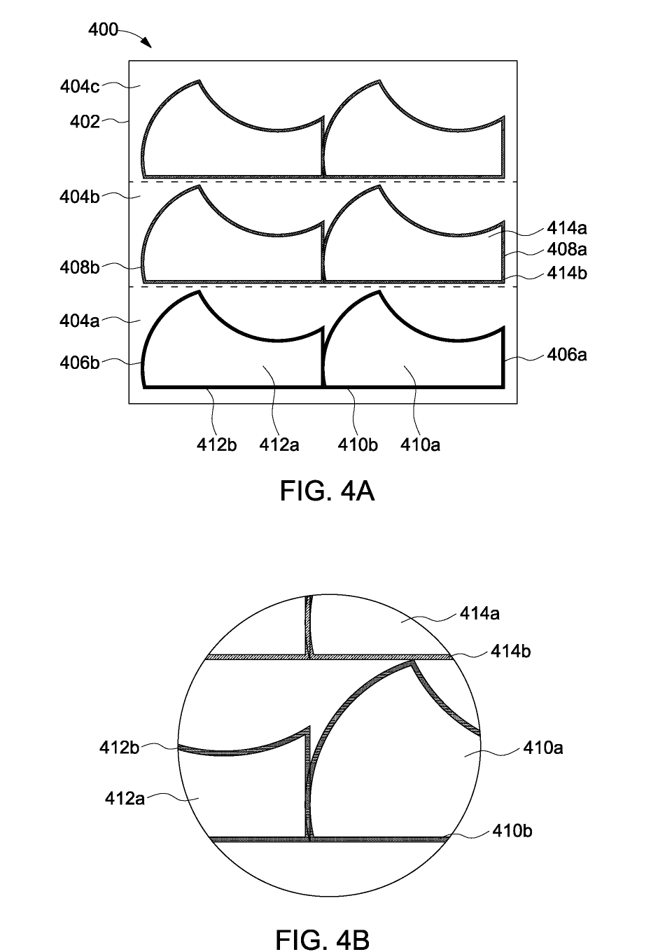

Referring now to FIGS. 4A and 4B, an exemplary nesting layout 400 of 2D part drawings with superimposable toolpaths for multi-head cutting machines is illustrated, in accordance with an embodiment. In FIG. 4A, the nesting layout 400 is shown. The nesting layout 400 may be generated for a 2D sheet drawing 402. The nesting layout 400 may include three regions (i.e., a region 404a, a region 404b, and a region 404c) corresponding to three cutting heads of a multi-head cutting machine. It should be noted that for ease of illustration, hypothetical guidelines are shown to demarcate the three regions on the 2D sheet drawing 402. An actual nesting layout may not be accompanied by such hypothetical guidelines. Each region may correspond to a cutting head of a multi-head cutting machine. For example, during a cutting operation, a first head (such as a master head) of the multi-head cutting machine may cut in the region 404a and a second head (such as a slave head) of the multi-head cutting machine may cut in the region 404b.

Additionally, the nesting layout 400 may include two copies of a 2D part drawing nested in each of the three regions. Thus, the 2D sheet drawing 402 may include 6 nested copies. By way of an example, the region 404a includes a first copy 406a and a second copy 406b. Similarly, the region 404b includes a first copy 408a and a second copy 408b. It should be noted that the first copy 406a is nested at the same relative orientation and position as the first copy 408a.

Each of the 6 nested copies may include a part region and a toolpath region. For example, the first copy 406a includes a part region 408a and a toolpath region 408b. Additionally, the second copy 406b includes a part region 410a and a toolpath region 410b. Also, the first copy 408a includes a part region 412a and a toolpath region 412b. It should be noted that the toolpath region of each of the two copies nested within a region is superimposable with toolpath regions of the other copies in the region. Thus, for example, the toolpath region 410b is superimposable with the toolpath region 408b. However, the toolpath region 410b is not superimposable with the toolpath region 414b because the the toolpath region 410b is positioned in the region 404a and the toolpath region 414b is positioned in the region 404b.

In FIG. 4B, overlapping between toolpaths of adjacent copies is shown. For example, the toolpath region 410b overlaps with the toolpath region 408b. At the same time, the toolpath region 410b does not overlap with the toolpath region 412b. Thus, advantageously, the nesting layout 400 is an optimal nesting layout that reduces wastage of raw material (i.e., 2D sheet) and saves total cutting time required to cut all the 2D parts from the 2D sheet through the multi-head cutting machine.

As will be also appreciated, the above-described techniques may take the form of computer or controller implemented processes and apparatuses for practicing those processes. The disclosure can also be embodied in the form of computer program code containing instructions embodied in tangible media, such as floppy diskettes, solid state drives, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

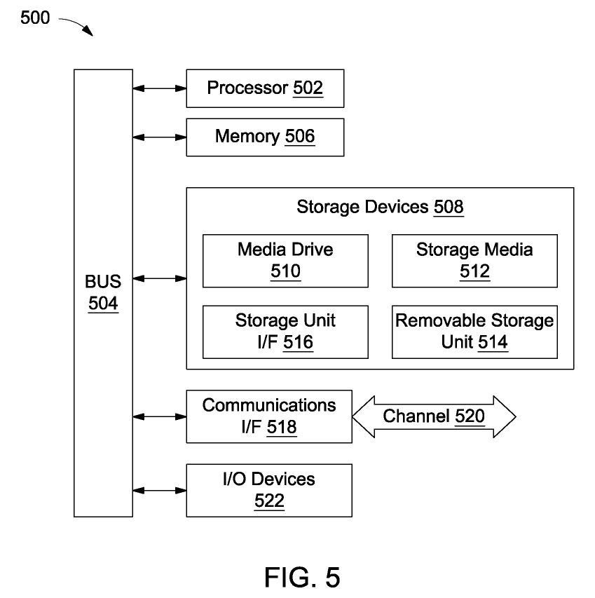

The disclosed methods and systems may be implemented on a conventional or a general-purpose computer system, such as a personal computer (PC) or server computer. Referring now to FIG. 5, an exemplary computing system 500 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 500 may represent, for example, a user device such as a desktop, a laptop, a mobile phone, personal entertainment device, DVR, and so on, or any other type of special or general-purpose computing device as may be desirable or appropriate for a given application or environment. The computing system 500 may include one or more processors, such as a processor 502 that may be implemented using a general or special purpose processing engine such as, for example, a microprocessor, microcontroller or other control logic. In this example, the processor 502 is connected to a bus 504 or other communication medium. In some embodiments, the processor 502 may be an Artificial Intelligence (AI) processor, which may be implemented as a Tensor Processing Unit (TPU), or a graphical processor unit, or a custom programmable solution Field-Programmable Gate Array (FPGA).

The computing system 500 may also include a memory 506 (main memory), for example, Random Access Memory (RAM) or other dynamic memory, for storing information and instructions to be executed by the processor 502. The memory 506 also may be used for storing temporary variables or other intermediate information during execution of instructions to be executed by the processor 502. The computing system 500 may likewise include a read only memory (“ROM”) or other static storage device coupled to bus 504 for storing static information and instructions for the processor 502.

The computing system 500 may also include a storage devices 508, which may include, for example, a media drive 510 and a removable storage interface. The media drive 510 may include a drive or other mechanism to support fixed or removable storage media, such as a hard disk drive, a floppy disk drive, a magnetic tape drive, an SD card port, a USB port, a micro USB, an optical disk drive, a CD or DVD drive (R or RW), or other removable or fixed media drive. A storage media 512 may include, for example, a hard disk, magnetic tape, flash drive, or other fixed or removable medium that is read by and written to by the media drive 510. As these examples illustrate, the storage media 512 may include a computer-readable storage medium having stored therein particular computer software or data.

In alternative embodiments, the storage devices 508 may include other similar instrumentalities for allowing computer programs or other instructions or data to be loaded into the computing system 500. Such instrumentalities may include, for example, a removable storage unit 514 and a storage unit interface 516, such as a program cartridge and cartridge interface, a removable memory (for example, a flash memory or other removable memory module) and memory slot, and other removable storage units and interfaces that allow software and data to be transferred from the removable storage unit 514 to the computing system 500.

The computing system 500 may also include a communications interface 518. The communications interface 518 may be used to allow software and data to be transferred between the computing system 500 and external devices. Examples of the communications interface 518 may include a network interface (such as an Ethernet or other NIC card), a communications port (such as for example, a USB port, a micro USB port), Near field Communication (NFC), etc. Software and data transferred via the communications interface 518 are in the form of signals which may be electronic, electromagnetic, optical, or other signals capable of being received by the communications interface 518. These signals are provided to the communications interface 518 via a channel 520. The channel 520 may carry signals and may be implemented using a wireless medium, wire or cable, fiber optics, or other communications medium. Some examples of the channel 520 may include a phone line, a cellular phone link, an RF link, a Bluetooth link, a network interface, a local or wide area network, and other communications channels.

The computing system 500 may further include Input/Output (I/O) devices 522. Examples may include, but are not limited to a display, keypad, microphone, audio speakers, vibrating motor, LED lights, etc. The I/O devices 522 may receive input from a user and also display an output of the computation performed by the processor 502. In this document, the terms “computer program product” and “computer-readable medium” may be used generally to refer to media such as, for example, the memory 506, the storage devices 508, the removable storage unit 514, or signal(s) on the channel 520. These and other forms of computer-readable media may be involved in providing one or more sequences of one or more instructions to the processor 502 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into the computing system 500 using, for example, the removable storage unit 514, the media drive 510 or the communications interface 518. The control logic (in this example, software instructions or computer program code), when executed by the processor 502, causes the processor 502 to perform the functions of the invention as described herein.

Thus, the disclosed method and system try to overcome the technical problem of generating nesting layouts for multi-head cutting machines. The disclosed method and system may receive a 2D sheet drawing, one or more 2D part drawings, and a set of nesting parameters from a UI. The set of nesting parameters may include a number of cutting heads of a multi-head cutting machine, dimensions of the 2D sheet drawing, dimensions of the 2D part drawing, and a limiting nesting number of copies of each of the one or more 2D part drawings. Each of the one or more 2D part drawings may include a part region and a toolpath region. Further, the disclosed method and system may create a plurality of regions on the 2D sheet drawing based on the number of the cutting heads. Each of the plurality of the regions corresponds to a cutting head of the multi-head cutting machine. Further, for each region of the plurality of regions, the disclosed method and system may fit a set of copies of each of the one or more 2D part drawings in the region at an optimal orientation and at an optimal position, to obtain a plurality of nested copies in the region. The toolpath region of each of the plurality of nested copies is superimposable with toolpath regions of remaining of the plurality of nested copies. The set of copies is based on the set of nesting parameters.

As will be appreciated by those skilled in the art, the techniques described in the various embodiments discussed above are not routine, or conventional, or well understood in the art. The techniques may generate nesting layouts that allow for cutting of same 2D part shape with same orientation by multiple cutting heads simultaneously at the time of cutting by a multi-head cutting machine. This leads to reduction in total cutting time required to cut all the 2D part shapes from the 2D sheet. Additionally, the techniques provide for toolpath overlapping when generating the nesting layouts. This prevents wastage of raw material during a multi-head cutting operation.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps clearly bring an improvement in the functioning of the device itself as the claimed steps provide a technical solution to a technical problem.

The specification has described method and system for generating nesting layouts for multi-head cutting machines. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for generating nesting layouts for multi-head cutting machines, the method comprising:
receiving, by a computing device, a 2D sheet drawing, one or more 2D part drawings, and a set of nesting parameters from a User Interface (UI), wherein the set of nesting parameters comprises a number of cutting heads of a multi-head cutting machine, dimensions of the 2D sheet drawing, dimensions of the 2D part drawing, and a limiting nesting number of copies for each of the one or more 2D part drawings, and wherein each of the one or more 2D part drawings comprises a part region and a toolpath region;
creating, by the computing device, a plurality of regions on the 2D sheet drawing based on the number of the cutting heads, wherein each of the plurality of the regions corresponds to a cutting head of the multi-head cutting machine; and
for each region of the plurality of regions,
fitting, by the computing device, a set of copies of each of the one or more 2D part drawings in the region at an optimal orientation and at an optimal position, to obtain a plurality of nested copies in the region, wherein the toolpath region of each of the plurality of nested copies is superimposable with toolpath regions of remaining of the plurality of nested copies, and wherein the set of copies is based on the set of nesting parameters.

2. The method as claimed in claim 1, further comprising:
discretizing geometric data of the 2D sheet drawing to obtain a sheet pixel map; and
for each copy of the set of copies of each of the one or more 2D part drawings,
discretizing geometric data of the copy to obtain a copy pixel map, wherein the copy pixel map comprises a part region pixel map corresponding to the part region and a toolpath pixel map corresponding to the toolpath region, and wherein the toolpath pixel map is a superimposable pixel map when fitted on the sheet pixel map.

3. The method as claimed in claim 1, wherein for each 2D part drawing of the one or more 2D part drawings, the set of copies fitted on the 2D sheet drawing is less than or equal to the limiting nesting number of copies for the 2D part drawing received in the set of nesting parameters.

4. The method as claimed in claim 1, wherein fitting the set of copies of each of the one or more 2D part drawings comprises:
for each copy of the set of copies of each of the one or more 2D part drawings,
determining the optimal position of the copy based on one of:
a position of a previously fitted copy in the region, or
a predefined corner of the region; and
determining the optimal orientation of the copy based on a geometric intersection between two or more adjacent nested copies of the plurality of nested copies.

5. The method as claimed in claim 1, wherein for each copy of the set of copies, the optimal orientation and the optimal position of the copy are same in each of the plurality of regions on the 2D sheet drawing.

6. A system for generating nesting layouts for multi-head cutting machines, the system comprising:
a processor; and
a memory communicatively coupled to the processor, wherein the memory stores processor instructions, which when executed by the processor, cause the processor to:
receive a 2D sheet drawing, one or more 2D part drawings, and a set of nesting parameters from a User Interface (UI), wherein the set of nesting parameters comprises a number of cutting heads of a multi-head cutting machine, dimensions of the 2D sheet drawing, dimensions of the 2D part drawing, and a limiting nesting number of copies of each of the one or more 2D part drawings, and wherein each of the one or more 2D part drawings comprises a part region and a toolpath region;
create a plurality of regions on the 2D sheet drawing based on the number of the cutting heads, wherein each of the plurality of the regions corresponds to a cutting head of the multi-head cutting machine; and
for each region of the plurality of regions,
fit a set of copies of each of the one or more 2D part drawings in the region at an optimal orientation and at an optimal position, to obtain a plurality of nested copies in the region, wherein the toolpath region of each of the plurality of nested copies is superimposable with toolpath regions of remaining of the plurality of nested copies, and wherein the set of copies is based on the set of nesting parameters.

7. The system of claim 6, wherein the processor instructions, on execution, further cause the processor to:
discretize geometric data of the 2D sheet drawing to obtain a sheet pixel map; and
for each copy of the set of copies of each of the one or more 2D part drawings,
discretize geometric data of the copy to obtain a copy pixel map, wherein the copy pixel map comprises a part region pixel map corresponding to the part region and a toolpath pixel map corresponding to the toolpath region, and wherein the toolpath pixel map is a superimposable pixel map when fitted on the sheet pixel map.

8. The system of claim 6, wherein for each 2D part drawing of the one or more 2D part drawings, the set of copies fitted on the 2D sheet drawing is less than or equal to the limiting nesting number of copies of the 2D part drawing received in the set of nesting parameters.

9. The system of claim 6, wherein to fit the set of copies of each of the one or more 2D part drawings, the processor instructions, on execution, further cause the processor to:
for each copy of the set of copies of each of the one or more 2D part drawings,
determine the optimal position of the copy based on one of:
a position of a previously fitted copy in the region, or
a predefined corner of the region; and
determine the optimal orientation of the copy based on a geometric intersection between two or more adjacent nested copies of the plurality of nested copies.

10. The system of claim 6, wherein for each copy of the set of copies, the optimal orientation and the optimal position of the copy are same in each of the plurality of regions on the 2D sheet drawing.

11. A non-transitory computer-readable medium storing computer-executable instructions for generating nesting layouts for multi-head cutting machines, the computer-executable instructions configured for:
receiving a 2D sheet drawing, one or more 2D part drawings, and a set of nesting parameters from a User Interface (UI), wherein the set of nesting parameters comprises a number of cutting heads of a multi-head cutting machine, dimensions of the 2D sheet drawing, dimensions of the 2D part drawing, and a limiting nesting number of copies of each of the one or more 2D part drawings, and wherein each of the one or more 2D part drawings comprises a part region and a toolpath region;
creating a plurality of regions on the 2D sheet drawing based on the number of the cutting heads, wherein each of the plurality of the regions corresponds to a cutting head of the multi-head cutting machine; and
for each region of the plurality of regions,
fitting a set of copies of each of the one or more 2D part drawings in the region at an optimal orientation and at an optimal position, to obtain a plurality of nested copies in the region, wherein the toolpath region of each of the plurality of nested copies is superimposable with toolpath regions of remaining of the plurality of nested copies, and wherein the set of copies is based on the set of nesting parameters.

12. The non-transitory computer-readable medium of claim 11, wherein the computer-executable instructions are further configured for:
discretizing geometric data of the 2D sheet drawing to obtain a sheet pixel map; and
for each copy of the set of copies of each of the one or more 2D part drawings,
discretizing geometric data of the copy to obtain a copy pixel map, wherein the copy pixel map comprises a part region pixel map corresponding to the part region and a toolpath pixel map corresponding to the toolpath region, and wherein the toolpath pixel map is a superimposable pixel map when fitted on the sheet pixel map.

13. The non-transitory computer-readable medium of claim 11, wherein for each 2D part drawing of the one or more 2D part drawings, the set of copies fitted on the 2D sheet drawing is less than or equal to the limiting nesting number of copies of the 2D part drawing received in the set of nesting parameters.

14. The non-transitory computer-readable medium of claim 11, wherein for fitting the set of copies of each of the one or more 2D part drawings, the computer-executable instructions are further configured for:
for each copy of the set of copies of each of the one or more 2D part drawings,
determining the optimal position of the copy based on one of:
a position of a previously fitted copy in the region, or
a predefined corner of the region; and
determining the optimal orientation of the copy based on a geometric intersection between two or more adjacent nested copies of the plurality of nested copies.

15. The non-transitory computer-readable medium of claim 11, wherein for each copy of the set of copies, the optimal orientation and the optimal position of the copy are same in each of the plurality of regions on the 2D sheet drawing.
